(19) United States
(12) Patent Application Publication
(10) Pub. No.: US 2023/0168117 A1
(43) Pub. Date: Jun. 1, 2023

(54) APPARATUS FOR THE DELIVERY OF GAS TO A USER

(71) Applicant: PIETRO FIORENTINI S.p.A., Arcugnano (VI) (IT)

(72) Inventors: Pietro CERAMI, Seveso (MB) (IT); Armando AMADINI, Castel Mella (BS) (IT)

(73) Assignee: PIETRO FIORENTINI S.p.A., Arcugnano (VI) (IT)

(21) Appl. No.: 17/921,552

(22) PCT Filed: Apr. 26, 2021
(86) PCT No.: PCT/IB2021/053402

§ 371 Date: Oct. 26, 2022

(30) Foreign Application Priority Data
Apr. 27, 2020 (IT) 102020000009103

(51) Int. Cl. G01F 15/00; G01F 15/063

(52) U.S. Cl. CPC G01F 15/002; G01F 15/003; G01F 15/005; G01F 15/063

(57) ABSTRACT

An apparatus for the delivery of gas to a user of the type suitable to be crossed at least in part by a flow of gas from a supply network includes:
a containment casing having at least one gas inlet opening and at least one gas outlet opening,
a measurement module of the gas passing through and/or circulates in the apparatus, housed inside the containment casing and fluidically connected to the at least one outlet opening,
a regulation module having a device for regulating the pressure of the gas that passes through and/or circulates in the apparatus,
an interception module that is placed between the regulation module and the measurement module. The interception module is configured to selectively allow/prevent the passage of the gas flow towards the measuring module, and is electronically connected with said electronic unit to be thus controlled by said electronic unit.

### FIELD OF THE INVENTION

The present invention refers to an apparatus for delivering gas to a user.

### BACKGROUND

At present, the users—and in particular the domestic users—are configured to operate with a gas flow that has a relative pressure lower than 0.1 barg (i.e., an absolute pressure lower than 1.1 bar), which is normally called “low pressure”.

However, currently, there are also some users—for example in Italy there are about 600,000 users (3% of the total) of this type—which, for technical and/or economic reasons, are served by a medium pressure distribution network, i.e., with a relative pressure between 0.5 and 5 barg (i.e., with an absolute pressure between 1.5 and 6 bar).

Furthermore, currently the general trend for new users is to supply gas at medium pressure.

The supply of gas to users through medium pressure networks requires, in addition to the meter for the metering of gas consumption, also a reducer device to reduce the gas pressure to values useful for the users' uses. In particular, these values are imposed by law and regulated by the sector legislation, which defines, among other things, the characteristics and safety criteria that the reducer devices useful for this purpose must have.

In this regard, it should also be considered that gas distributors are very sensitive to the safety aspect as a failure of the reducing device could compromise the safety and security of people and property.

For this purpose and in this context, regulators with double regulation and block stage are generally used as a reducing device to reduce the gas pressure.

On the other hand, as gas meters, the use of “smart” meters—called “smart meters” or “remote managed meters”—is increasingly widespread, which are used to measure the consumption (private and industrial) of the amount of energy consumed in the form of gas. In particular, these meters are equipped with and/or are associated with sensors that directly measure the (operating) flow rate of the gas, and subsequently, by means of suitable equations and algorithms, convert it into corresponding volume values related to the reference thermodynamic conditions (expressed in standard cubic meters or Sm³ or Nm³). Conveniently, for this purpose, these meters are provided with and/or associated with sensors which also measure the temperature and (working) pressure of the gas. In essence, digitalization has now forcefully entered the measurement of gas, expanding the possibilities of use from mere measurement to other useful functions, such as the conversion of volumes, control and interception of the supply.

Therefore, at the point of delivery of medium pressure gas to a user, to date, a pressure reducer/regulator device, a meter (preferably a smart meter) for measuring the gas and flow of gas shut-off devices are installed. Currently, these three elements are installed and operate independently of each other. Furthermore, the overall dimensions defined by the assembly of these three elements is much greater than that of the corresponding assembly used for the delivery of low pressure gas.

EP2251652, JP2009115496, JP2006162455 and EP2383552 already describe appliances for the delivery of gas to a user which include a containment casing, with an opening for the gas inlet and an opening for the gas outlet, a measurement and a regulation module for the gas that passes through and/or circulates in the appliance.

### SUMMARY

The object of the invention is to propose an apparatus, for the delivery of gas to a user, which allows to overcome the drawbacks of the known solutions.

Another object of the invention is to propose an apparatus which is suitable for being connected and/or used in a medium pressure distribution network.

Another object of the invention is to propose an appliance which can be easily and quickly installed, as well as replaceable, at the point of delivery to a user of the gas, supplied by a distribution network, and which is simple and intuitive to use.

Another object of the invention is to propose an apparatus which has high safety standards.

Another object of the invention is to propose an apparatus which allows an accurate and precise calculation of gas volumes, also for fiscal purposes.

Another object of the invention is to propose an apparatus which allows to detect data and characteristics of the gas which passes through it and which is intended to be supplied to users.

Another object of the invention is to propose an apparatus which is an improvement and/or alternative to the traditional ones.

Another object of the invention is to propose an apparatus which is highly compact and integrated.

Another object of the invention is to propose an apparatus which can be manufactured simply, quickly and at low costs.

Another object of the invention is to propose an apparatus with an alternative characterization, both in constructive and functional terms, with respect to the traditional ones.

All the purposes mentioned here, considered both individually and in any combination thereof, and others still which will result from the following description, are achieved, according to the invention, with an apparatus as defined in the appended claims.

### BRIEF DESCRIPTION OF THE DRAWINGS

The present invention is further below clarified in some of its preferred embodiments reported for purely illustrative and non-limiting purposes with reference to the attached drawings, in which:

FIG. 1 shows a block diagram of the apparatus according to the invention, and

FIG. 2 shows in schematic view of the apparatus according to the invention.

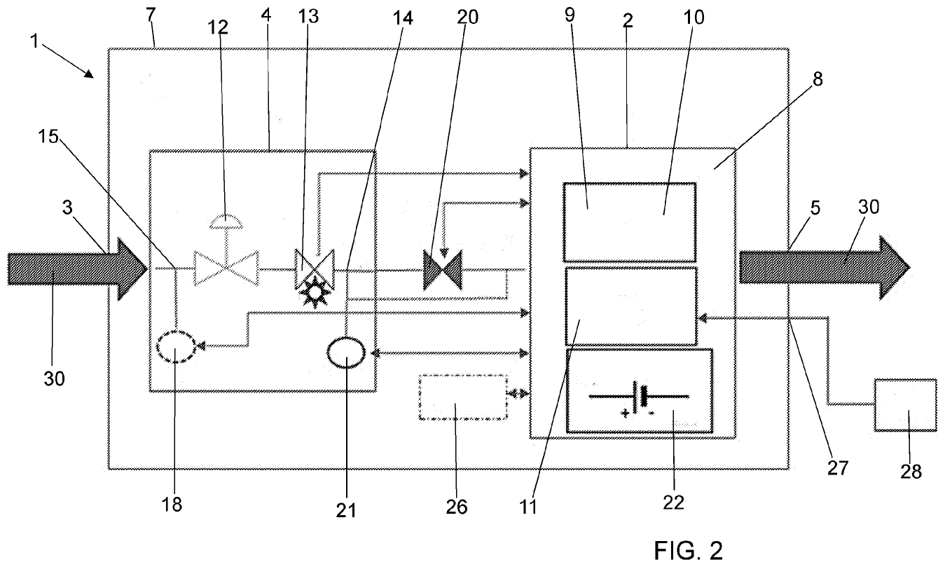

### DETAILED DESCRIPTION OF THE PREFERRED EMBODIMENTS

As can be seen from the figures, the apparatus 1 according to the invention, for delivering gas to a user, is of the type configured to be crossed, at least in part, by a flow of gas coming from a supply network and to be supplied to said user.

Conveniently, the apparatus 1 is of the type configured to carry out the delivery and also the measurement of the gas which comes from a supply network and which, passing through the apparatus, is supplied to a user. Preferably, the device is suitable for carrying out a gas measurement for tax purposes and, in particular, it is configured to comply with the technical requirements defined by national or regional legislation (for example European) in order to be used in commercial transactions.

Conveniently, the apparatus 1 is configured to carry out a gas measurement that can be used for the metering of gas consumption by the user to which the apparatus is connected.

Conveniently, apparatus 1 is designed and configured to be installed and used in a medium pressure gas distribution network, i.e., with a relative pressure between 0.5 and 5 barg (i.e., with an absolute pressure between 1.5 and 6 bar).

In particular, apparatus 1 is intended to be connected at the inlet/upstream with a medium pressure gas distribution network, and to be connected at the outlet/downstream with a user that is intended to receive and be refueled with the gas of said gas distribution network.

Conveniently, the apparatus 1 is provided with at least one gas inlet 30, for example connected to a pipe section provided upstream of the device 1, and with a fluid outlet, for example connected to a pipe section provided at downstream of said apparatus.

Conveniently, the apparatus 1 comprises a containment casing 7 in which are defined:

at least one inlet opening 3 to allow the fluid 30 to enter the inside of said enclosure, and

an outlet opening 5 to allow the fluid 30, which has entered/circulated in said casing 7, to escape from the latter.

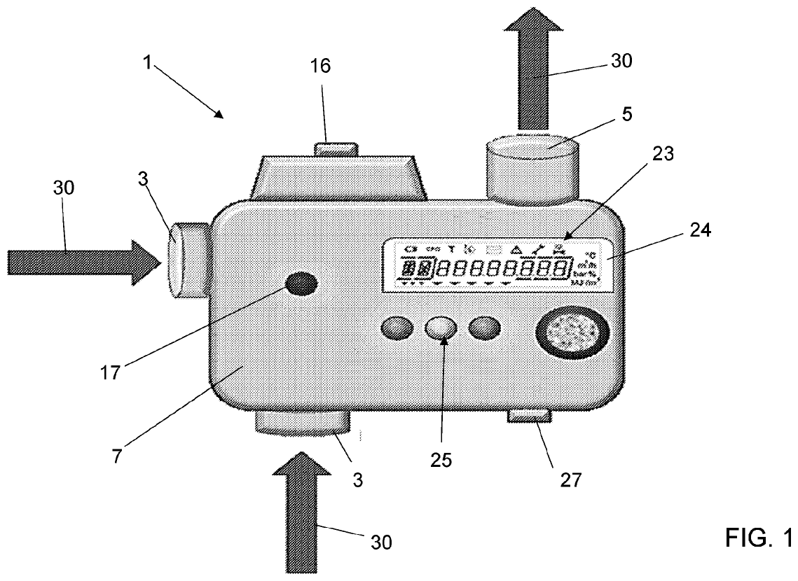

Advantageously, as shown in FIG. 1, the apparatus 1 is provided with at least two gas inlet openings 3 which are defined/provided in two distinct and spaced parts of said casing. Conveniently, said at least two inlet openings 3 are defined/provided in two different walls of the casing 7, preferably in correspondence with two mutually angled and/or substantially perpendicular walls; for example, a first inlet opening 3 can be defined/provided in correspondence with a side wall, while another inlet opening 3 can be provided in correspondence with an upper or lower wall of the enclosure. Advantageously, this allows the gas 30 to enter from two possible directions, thus facilitating the installation of the apparatus 1 in existing plants/contexts. Conveniently, said at least two inlet openings 3 can be defined/provided in the same wall of the casing, even if they are spaced apart. Conveniently, it is understood that, once one of the two inlet openings 3 is connected to the pipe of the gas distribution network, the other inlet opening is then closed/sealed.

Preferably, the containment casing 7 is watertight to prevent the escape of gas to the outside. Preferably, it is formed by two or more parts joined together so as to guarantee the hermetic sealing of the entire casing 7. Preferably, the containment casing 7 is made of metal, in particular of metal sheet.

In particular, the apparatus 1 is of the type configured to perform a series of measurements on the flow of gas that passes through and/or circulates in said apparatus, and also to regulate the pressure of said flow of gas that passes through and/or circulates in said apparatus.

Conveniently, for this purpose, apparatus 1 comprises:

a module 2 for measuring the gas flow 30 which passes through and/or circulates in said apparatus, and

a module 4 for regulating the gas flow 30 which passes through and/or circulates in said apparatus.

Conveniently, both the measurement module 2 and the regulation module 4 are housed inside the containment casing 7 and are fluidically connected to each other. Preferably, the measuring module 2 and the regulation module are also electronically connected to each other.

In particular, the regulation module 4 is positioned upstream of the measurement module 2 with respect to the direction of advancement of the gas flow 30 which crosses the inside of the containment casing 7 going from the inlet opening 3 towards the outlet 5.

Conveniently, the inlet of the regulation module 4 is fluidically connected to said gas inlet opening 3 inside the containment casing 7, while the inlet of the measuring module 2 is fluidically connected with the outlet of the regulation module 4. Conveniently, the outlet of the measuring module 2 is fluidically connected to the gas outlet opening 5 of the containment casing 7.

Preferably, said measuring module 2 and said regulation module 4 are connected in order to work synergistically.

Conveniently, the measurement module 2 is configured to carry out at least one gas measurement 30 useful for tax purposes and, in particular, it is configured to comply with the technical requirements defined by national or regional legislation (for example European) in order to be used in commercial transactions.

Preferably, the measurement module 2 can be of a traditional type in itself and, suitably, comply with the regulatory requirements currently in force. Preferably, the measurement module 2 is of the type generally envisaged in “smart meters” meters.

Conveniently, the regulation module 4 can be of a traditional type and comply with the regulatory requirements currently in force.

Conveniently, the measuring module 2 comprises at least one measuring device 8 configured to detect at least one quantity of the gas flow that enters and passes through said apparatus 1. Preferably, the measuring device 2 can comprise sensors configured to measure a plurality of properties and/or characteristic values relating to the gas flow that passes through the apparatus 1.

For example, in the measurement module 2 there is a measurement device 8 that can be configured to measure the quantity of gas 30 that passes through the apparatus 1 in a specific period of time. Furthermore, in the measuring module 2 further measuring devices 8 can be provided which are configured to measure other properties of the fluid, such as pressure, velocity, composition and/or degree of impurity present, temperature, etc. Preferably, the measuring devices can be configured to also measure the upper and/or lower calorific value and/or other properties and/or characteristic values of the gas. Preferably, the measurement module 2 can comprise a gas measurement device of the type defined in the Italian patent application No. 102019000009168.

Conveniently, the measurement module 2 comprises a measurement device 8 which uses static type technologies for the measurement of the gas flow rate, preferably ultrasonic or thermo-mass. Advantageously, the use of this technology allows to detect reduced flow rates (for example ≤ to about 2 dmc/h) in a short time (for example ≤ to about 2 s).

The apparatus 1 comprises an electronic unit 11 which is electronically connected to said measurement module 2 and to said regulation module 4. Preferably, said electronic unit 11 is incorporated/mounted on said measurement module 2 and is electronically connected to the components of said regulation module 4 and any other components with which the apparatus 1 is provided.

In particular, said electronic unit 11 is configured to control/command at least one component of the measurement module 2 and to also control/command at least one component of the regulation module 4. Preferably, said electronic unit 11 is configured to receive and process the data detected by the sensors of the measurement module 2, and is also configured to command/control the regulation module 4.

Advantageously, said electronic unit 11 is configured to act as a control and command unit, and preferably also for processing and/or storage, for said apparatus 1.

The electronic unit 11 can be housed within the casing 7 of the apparatus 1 or, according to a form of embodiment not shown, it may be associated externally to the wall of said casing 7.

Advantageously, the electronic unit 11 it can be part of the measurement module 2 and, in particular, it can comprise and/or be defined by the processing unit which is configured to receive and process the readings (measurements) made and coming from the sensors of the device 8 of the measurement module 2.

Preferably, said electronic control unit 11 is implemented by a corresponding processor. Conveniently, said electronic unit 11 is defined by an electronic board, (for example a printed circuit PCB) in which a microprocessor or a microcontroller is housed.

Preferably, the electronic unit 11 is housed inside the casing 7, is mounted on the measurement module 2 and is configured to act as a processing unit.

The apparatus 1 also comprises means 9 for remote data communication (not shown), preferably means for transmitting or transmitting with a possible remote unit. Conveniently, said communication means 9 can be of the wireless type (in particular via infrared or via radio, for example Wi-Fi). Conveniently, these communication means 9 can be connected and/or integrated in the measurement module 2. Preferably, the communication means 9 can be configured to allow the apparatus 1 to interact and exchange data and/or information and/or commands with an external portable device (not shown), such as a smartphone or tablet. Advantageously, the communication means 9 can be configured to allow the apparatus 1 to interact and exchange data and/or information and/or commands with an external processing unit. Preferably, the external processing unit can define an external central unit—preferably remote, for example a SAC (i.e., central acquisition system)—which is configured to receive data and/or information from one or more devices 1.

The apparatus 1 also comprises a storage unit 10 for recording data relating to the manufacturing characteristics of the apparatus 1 and/or its operation, preferably concerning the quantities (possibly processed) detected by the sensors of the measurement module 2. Conveniently, the storage unit 10 is connected and/or integrated in the measurement module 2.

Preferably, the measurement module 2 comprises the storage unit 10 and the remote data communication means 9.

Preferably, the electronic unit 11 of the measurement module 2 controls and commands the measurement device 8 (and therefore the measurement functions), the management of the gas supply to the user, the storage unit 10 (and therefore the data storage/recording) and the means 9 for communicating data from/to the outside.

Advantageously, the regulation module 4 comprises a device 12 for regulating the flow of gas 30 which passes through it, in particular for regulating its pressure. Preferably, said regulating device 12 comprises a valve, or a valve assembly, for regulating the flow of gas passing through it. Preferably, said regulating device 12 is self-operated and has a double stage. Preferably, the regulating device 12, and its operating principle, is of the traditional type.

Advantageously, the regulation module 4 comprises at least one shut-off device 13 which is configured to selectively allow/prevent the passage of the gas flow 30 towards said measurement module 2. Conveniently, the shut-off device 13 controls the gas flow 30 towards the measurement module 2. Preferably, said shut-off device 13 comprises an on-off type valve configured to selectively allow/prevent the passage of the gas flow 30 passing through it.

Conveniently, inside the regulation module 4, the regulating device 12 is positioned upstream of the shut-off device 13 with respect to the direction of advance of the gas, inside the casing 7, from the inlet opening 3 towards the outlet opening 5.

Conveniently, said shut-off device 13 is a safety device and, advantageously, its actuation—preferably mechanical—is not controlled by said electronic unit. Conveniently, said shut-off device 13 is electronically connected with said electronic unit 11 only to send signals representative of its actuation and/or operating state (open or closed).

Conveniently, said at least one shut-off device 13 is configured in such a way that, without any conditioning/command by the electronic unit 11, it automatically and autonomously intercepts the gas flow 30 should anomalous pressure or flow conditions arise.

In particular, said at least one shut-off device 13 is configured to intervene upon the occurrence of at least one of said situations:

pressure rise in an area downstream 14 of the shut-off device 13,

pressure drop in an area 14 downstream of the shut-off device 13,

lack of pressure in an upstream area 15 of the shut-off device 13;

increase in the flow rate, which flows through apparatus 1, between 110% and 150% compared to the nominal flow rate of the apparatus.

Conveniently, said at least one shut-off device 13 can comprise an overflow valve 16 which allows a small quantity of gas to be discharged into the atmosphere, when the pressure in the downstream area 14 of said shut-off device 13 exceeds a predetermined value beyond the maximum of lock-up. Conveniently, the pressure value for triggering the intervention of the relief valve 16 is normally lower than that foreseen for the intervention in the event of a rise in pressure in the downstream area 14 and which would result in the interruption of the service. Conveniently, the overflow valve 16 can intervene following a thermal expansion of the gas in the downstream area 14 in the absence of flow, and in this case its reset takes place automatically.

Advantageously, the apparatus 1 can also comprise a command (for example a button 17), which can be activated manually from the outside of the casing 7, to command the reopening (rearming) of the shut-off device 13 of the regulation module 4, once said device has been activated to thus block the passage of gas towards the measurement module 4 and therefore towards the outlet opening 5 of the apparatus 1. In essence, the restoration of operation of the apparatus 1, following the interruption of the passage of the gas deriving from the actuation of said at least one shut-off device 13, must be carried out manually, preferably by acting on a button 17 dedicated to this purpose.

Conveniently, when said at least one shut-off device 13 is activated to interrupt the passage of gas 30, the device itself sends a corresponding signal to the electronic unit 11 which, preferably, is configured to then send a corresponding alarm to a remote unit, for example at the SAC.

Preferably, the regulating module 4 can comprise an inlet pressure sensor 18, preferably positioned at the inlet of the regulating module 4, and in particular upstream of the regulating device 12. In particular, the inlet pressure sensor 18 is configured to detect the gas pressure entering the regulation module 4. Preferably, said inlet pressure sensor 18 is a relative pressure sensor. Conveniently, said inlet pressure sensor 18 is electronically connected to the electronic unit 11 to transmit to this the data representative of the measurements made.

The inlet pressure sensor 18 can be used to check and record the pressure values of the distribution network at the delivery point where the apparatus 1 is installed. Advantageously, the pressure values detected by the inlet pressure sensor 18 can also be used for smart grid functions.

Advantageously, still inside the casing 7, between the regulation module 4 and the measurement module 2, an interception module 20 is provided which is configured to selectively allow or interrupt the passage of gas that exits from the regulation module 4 enters the measurement module 2. In particular, the interception module 20 is fluidically connected upstream with the output of the regulation module 4 and downstream with the input of the measurement module 2. Preferably, the interception module 20 comprises an on-off valve, or valve assembly, configured to selectively allow/prevent the passage of the gas 30 passing through it.

Conveniently, the electronic unit 11 is electronically connected to the interception module 20 to correspondingly control its opening/closing; in particular, therefore, the interception module 20—unlike the shut-off device 13 of the regulation module 4—is controlled by the control unit 11. Conveniently, the interception module 20 also sends to the electronic unit 11 signals representative of the its operational state (open or closed).

Conveniently, therefore, the interception module 20 is configured to interrupt the flow of gas similarly to what is performed by said at least one shut-off device 13, however—unlike the latter—it can be operated by the electronic unit 11.

Conveniently, the actuation of the interception module 20 is controlled by the electronic unit 11 following commands from an external unit, preferably remote (for example from the SAC), and/or following commands generated in the face of processing implemented at software level in the electronic unit 11 and aimed, for example, at recognizing fraudulent attempts to withdraw gas and/or for safety reasons (for example earthquakes), or for functional reasons (prepayment).

Advantageously, moreover, the actuation of the interception module 20 can also be integrated with that of said at least one shut-off device 13 to intervene in cases similar/corresponding to those reported above for the intervention of said device 13, but with intervention thresholds modifiable and programmable (for example from the remote unit) and, preferably, more restrictive than the fixed ones provided for said at least one shut-off device 13. Conveniently, therefore, while said shut-off device 13 is configured to interrupt the passage of gas to the occurrence of predefined pressure or flow conditions, said interception module 20 is configured to interrupt the passage of gas upon occurrence of pressure or flow conditions which can be modified by means of corresponding commands sent by the electronic unit 11.

Conveniently, the apparatus 1 comprises at least a pressure sensor 21 which is positioned in the valley and of said regulating device 12 and upstream and/or at the inlet of said measurement module 2. Conveniently, said pressure sensor 21 is configured to detect the characteristics of the gas 30, and in particular its pressure, before its inlet in the measurement module. Conveniently, said pressure sensor 21 is electronically connected to the electronic unit 11 to transmit to this the data representative of the measurements made.

In particular, said electronic unit 11 is configured to use the data received and detected by said at least one pressure sensor 21 to detect/verify the operation of said regulation module 4.

Preferably, said pressure sensor 21 is a relative pressure sensor.

Preferably, said at least one pressure sensor 21 is positioned so as to detect the characteristics of the gas, and in particular its pressure, immediately downstream of said interception module 20 and/or immediately downstream of said shut-off device 13.

Conveniently, said at least one pressure sensor 21 can be positioned downstream of the regulating device 12, preferably between the shut-off device 13 and the interception module 20 (see FIG. 1). Conveniently, said pressure sensor 21 could also be positioned downstream of the interception module 20 (and therefore downstream of the regulating devices 12 and interception 13).

Conveniently, said at least one pressure sensor 21 can be provided inside the regulation module 4, downstream of the shut-off device 13, to thus detect the pressure of the gas leaving the regulation module 20.

Conveniently, said at least one sensor pressure 21 can be provided inside the interception module 20, at the inlet and/or outlet of said module.

Conveniently, said at least one pressure sensor 21 can be provided inside the measurement module 2, at the inlet of the latter.

Advantageously, the apparatus 1 comprises—preferably housed inside the measurement module 2—at least one source of electrical energy for the components of the apparatus and, in particular, both for the electronic unit and for the components (sensors and valves) of the measurement, regulation and interception modules. Preferably, said at least source of electrical energy comprises at least one storage unit 22 (battery or power cell); suitably, said storage unit 22 is connected directly or by means of the electronic board of the electronic unit 11 to the various components in order to supply the electrical energy for their operation.

Preferably, the storage unit 22 is connected and/or incorporated in the measurement module 2.

Advantageously, the apparatus 1 also comprises a user interface 23—for example a push-button panel 25 associated with a display 24 or a display of touch-screen type—configured to allow the user to interact with the electronic unit 11. Preferably, the display 24 shows the data received and/or processed by said electronic unit 11. Conveniently, the user interface 23 is provided at the exterior of said casing 7 and can be associated or spaced from the latter, while being electronically connected to the electronic unit 11.

Advantageously, the apparatus 1 can comprise a seismic sensor 26 for detecting vibrations, and in particular those due to earthquakes. Conveniently, said seismic sensor 26 is electronically connected to the electronic unit 11 to transmit the detected data to the latter.

Conveniently, the electronic unit 11 is configured in such a way that, when it is alerted by the seismic sensor 26, it commands the closure of the interception module 20, to thus prevent the passage of gas towards the measurement module 2 and from here, through the output opening 30, towards the user, and preferably also sends a warning signal to a remote unit (for example to the SAC). Conveniently, the electronic unit 11 is configured so that, once the effects of the earthquake are over (for example on the basis of the data provided by the seismic sensor 26), it performs a test based on the flow rate and on the pressure value measured by the pressure sensor. 21 positioned upstream of the measurement module 2, and if necessary, automatically restores the gas supply by reopening the interception module 20, and thus allowing the passage of gas towards the measurement module and from here, through the outlet opening 30, towards the user.

Advantageously, the apparatus 1 can also comprise a connector 27 which is associated with a corresponding interface, is provided in correspondence with the casing 7 and is connected to the electronic unit 11 housed inside the casing itself. Conveniently, said connector 27 is accessible from the outside of the casing 7 to allow the connection, by means of a data transmission cable (not shown), of the electronic unit 11 with an external apparatus 28.

Therefore, the connector 27 with the corresponding interface define a channel for data communication via cable to the outside of the device 1. In particular, advantageously, in this way, the data detected by the measuring device 8 and/or by the inlet pressure sensor 18 and/or from the pressure sensor 21 of the apparatus 1 and collected by the electronic unit 11, can be transferred from the latter to the external apparatus 28.

Conveniently, the electronic unit 11 and/or the external apparatus 28 are configured to perform, at least in part, appropriate calculations and processing of the data detected by the measuring device 8 and/or by the inlet pressure sensor 18 and/or by the pressure sensor 21, and this preferably in order to determine data relating to the quality of the gas passing through apparatus 1, such as for example the Higher Caloric Value (HCV), the temperature of the gas, the absolute pressure of the gas, the molar percentage of methane, carbon dioxide and hydrogen).

Advantageously, the data relating to the quality of the gas are used by the electronic unit 11 to calculate the energy of the gas associated with the flow rates of the gas that pass through the apparatus 1. Preferably, the data calculated and processed by the external apparatus 28 can then be retransmitted—preferably by means of the same data transmission cable connected to said connector 27—to the electronic unit 11 of the apparatus, and then used to calculate the higher calorific value (HCV) of the gas and therefore the energy associated with the measured volumes.

Conveniently, the electronic unit 11 is configured to receive signals, coming from said at least one pressure sensor 21 and/or from said inlet pressure 18 and representative of the pressure readings made by said sensors, and on the basis of said signals is able to verify/report:

the intervention/activation of the shut-off device 13, and therefore the interruption of the gas flow towards the measurement module, and/or

the pressure of the gas leaving the apparatus 1, and therefore supplied to the user, in particular indicating whether it is inside or outside the relative acceptability limits, and/or

the gas pressure entering apparatus 1, and therefore into the distribution network, in particular indicating whether it is inside or outside the relative acceptability limits, and/or

gas dispersions and leaks present in the user's system, and/or

the operation of the regulation module 4, in particular identifying any anomalies or functional deteriorations, to thus foresee possible wear of the members of the regulating device 12.

Advantageously, on the basis of the signals received from the pressure sensors 21 and/or 18, the electronic unit 11 can be configured to implement one or more functions inherent to smart grids.

The device 1 can be provided with a predictive maintenance functionality of the regulation module 4. Conveniently, the software for implementing this functionality can be loaded and executed directly from the electronic unit 11 of the device 1 or it can be loaded and executed in a ‘remote unit which receives the measured data and transmitted from the apparatus 1.

As is clear from what has been said the device according to the invention is particularly advantageous in that:

it has a smaller footprint and a lower cost than traditional solutions, in particular with respect to those currently used at the point of delivery of medium pressure gas to a user,

allows to simplify installation and maintenance;

it allows to monitor the gas supply conditions to a user and, moreover, it allows to detect interventions of the interception/protection devices, to check the status of the apparatus itself and also the network pressure at the delivery point,

by implementing a predictive diagnostics of the operation of the regulation module, it allows to prevent failures and malfunctions of said regulation module, thus optimizing the operation of the apparatus itself and also increasing its safety level,

enables and makes it possible to measure the energy of the gas that passes through it,

allows to implement smart grid for functions managing the gas distribution network in a “smart” way,

it allows to control the gas flow rate that flows towards the user, automatically interrupting the supply when said flow rate value exceeds safety limits or commercial limits that can be set, even remotely in a safe way.

The present invention has been illustrated and described in a preferred embodiment thereof, but it is understood that executive variations may be applied to it in practice, without however departing from the scope of protection of the present patent for industrial invention.

1. Apparatus (1) for the delivery of gas to a user, of the type suitable to be crossed at least in part by a flow of gas (30) coming from a supply network and to be supplied to said user, the apparatus comprising:
a containment casing (7) provided with at least one opening (3) for the gas to enter and at least one opening (5) for the gas exit,
a measurement module (2) of the gas (30) that passes through and/or circulates in said apparatus, said measurement module (2) being housed inside said containment casing (7) and being fluidically connected to said at least one opening (5) for the gas outlet, said measuring module (2) being provided with at least one device (8) for detecting a corresponding quantity of the gas flow (30) that passes through and/or circulates in said apparatus (1),
a regulation module (4) comprising at least one device (12) for regulating the pressure of the gas that (30) passes through and/or circulates in said apparatus, said regulation module (4) being housed inside said casing (7), being fluidically connected to said at least one opening (3) for the gas inlet and being positioned upstream of said measuring module (2) with respect to the direction of advance of the gas flow (30) from said inlet opening (3) towards said outlet opening (5), the same electronic unit (11), which is electronically connected and/or mounted in said measuring module (2) and which is also electronically connected with at least one pressure sensor (21), which is positioned downstream of said regulating device (12) and upstream and/or at the inlet of said measurement module (2) to detect/verify the operation of said regulation module (4),
the apparatus further comprising an interception module (20) that:
is placed between the regulation module (4) and the measurement module (2),
is configured to selectively allow/prevent the passage of the gas flow (30) towards said measuring module (2),
it is electronically connected with said electronic unit (11) to be thus controlled by said electronic unit (11).

2. The apparatus according to claim 1, wherein said interception module (20) is electronically connected with said electronic unit (11) to be thereby controlled by said electronic unit (11) on the basis of command signals sent from outside to said electronic unit (11).

3. The apparatus according to claim 1, wherein said interception module (20) is configured to interrupt the passage of gas upon the occurrence of pressure and/or flow rate conditions which can be modified by means of corresponding commands sent by the electronic unit (11).

4. The apparatus according to claim 1, wherein said regulation module (4) also comprises at least one gas flow (30) shut-off device (13).

5. The apparatus according claim 4, wherein said at least one gas flow (30) shut-off device (13) is positioned downstream of said regulating device (12) and being configured to selectively allow/prevent the passage of the gas flow (30) towards said measurement module (2).

6. The apparatus according to claim 5, wherein said at least one gas flow (30) shut-off device (13) is electronically connected with said electronic unit (11) only to send signals representative of its actuation and/or operating state, said shut-off device (13) not being controlled by said electronic unit (11).

7. The apparatus according to claim 5, wherein, said at least one gas flow (30) shut-off device (13) is configured to interrupt the passage of gas upon the occurrence of predefined pressure and/or flow rate conditions.

8. The apparatus according to claim 1, wherein said measurement module (2) is configured to carry out gas measurements (30) useful for tax purposes and, is configured to comply with the technical requirements defined by national or regional legislation in order to be used in commercial transactions.

9. The apparatus according to claim 1, wherein the measuring module (2) comprises a measuring device (8) which uses static type technologies for measuring the gas flow rate, either ultrasonic or thermo-mass.

10. The apparatus according to claim 1, wherein said at least one pressure sensor (21), which is positioned downstream of said regulating device (12) and upstream and/or inlet of said control module measure (2) is positioned between the shut-off device (13) and the interception module (20) and/or is positioned between the interception module (20) and the measurement module (2).

11. (canceled)

12. The apparatus according to claim 1, further comprising an inlet pressure sensor (18) which is positioned upstream of the regulating device (12) and which is electronically connected to the electronic unit.

13. The apparatus according to claim 1, further comprising:
means (9) for the communication, transmission and/or reception, of data at a distance,
a storage unit (10) for data recording,
a source of electrical energy, preferably a storage unit, to supply the components of the apparatus with electrical energy for their operation,
a user interface (23).

14. The apparatus according to claim 1, wherein the apparatus is provided with at least two gas inlet openings (3) which are defined/provided in two distinct and spaced parts of said casing.

15. The apparatus according to claim 1, wherein said electronic unit (11) is incorporated/mounted on said measuring module (2) and is electronically connected with the components of said regulation module (4) and with any other components the apparatus is equipped with (1).

16. The apparatus according to claim 1, wherein said electronic unit (11) is configured to receive and process the data detected by the sensors of the measurement module (2) and is also configured to command/control the measurement module adjustment (4).

17. (canceled)

18. The apparatus according to claim 1, wherein said at least one gas flow (30) shut-off device (13) is configured to intervene upon the occurrence of at least one of said situations:
pressure rise in an area downstream (14) of the shut-off device (13),
pressure drop in an area downstream (14) of the shut-off device (13),
lack of pressure in an area upstream (15) of the shut-off device (13)
increase in the flow rate that flows through the apparatus (1), between 110% and 150% with respect to the nominal flow rate of the apparatus.

19. The apparatus according to claim 1, further comprising a command, manually activated from the outside of the casing (7), to command reopening or rearming of the at least one gas flow (30) shut-off device (13) of the adjustment (4), once said device has been activated to block the passage of gas towards the measurement module (4).

20. The apparatus according to claim 1, wherein said interception module (20) is configured to also send to the electronic unit (11) signals representative of its open or closed operating state.

21. The apparatus according to claim 1, wherein:
said at least one gas flow (30) shut-off device (13) is configured to interrupt the passage of gas upon the occurrence of predefined pressure or flow conditions, and
said interception module (20) is configured to interrupt the passage of gas when pressure or flow conditions occur which can be modified by means of corresponding commands sent by the electronic unit (11).

22. (canceled)

23. Apparatus (1) for the delivery of gas to a user, of the type suitable to be crossed at least in part by a flow of gas (30) coming from a supply network and to be supplied to said user, the apparatus (1) comprising:
a containment casing (7) provided with at least one opening (3) for the gas to enter and at least one opening (5) for the gas exit,
a measurement module (2) of the gas (30) that passes through and/or circulates in said apparatus, said measurement module (2) being housed inside said containment casing (7) and being fluidically connected to said at least one opening (5) for the gas outlet, said measuring module (2) being provided with at least one device (8) for detecting a corresponding quantity of the gas flow (30) that passes through and/or circulates in said apparatus (1),
a regulation module (4) comprising at least one device (12) for regulating the pressure of the gas that (30) passes through and/or circulates in said apparatus, said regulation module (4) being housed inside said casing (7), being fluidically connected to said at least one opening (3) for the gas inlet and being positioned upstream of said measuring module (2) with respect to the direction of advance of the gas flow (30) from said at least one inlet opening (3) towards said at least one outlet opening (5), the same electronic unit (11), which is electronically connected and/or mounted in said measuring module (2) and which is also electronically connected with at least one pressure sensor (21), which is positioned downstream of said regulating device (12) and upstream and/or at the inlet of said measurement module (2) to detect/verify the operation of said regulation module (4),
further comprising an interception module (20) that:
is placed inside the containment casing (7),
is configured to selectively allow/prevent the passage of the gas flow (30) towards said at least one opening (5) for the gas exit, and
is electronically connected with said electronic unit (11) to be thus controlled by said electronic unit (11).
